(19) United States
(12) Patent Application Publication
(10) Pub. No.: US 2008/0077278 A1
(43) Pub. Date: Mar. 27, 2008

(54) TILT DETECTABLE AUTOMATICALLY-OPERATING CLEANER AND METHOD OF CONTROLLING THE SAME

(75) Inventors: Ho Joon PARK, Seoul (KR); Hyun Joon Kim, Gyunggi-do (KR); Kyoung Soo Chae, Gyunggi-do (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 11/859,650

(22) Filed: Sep. 21, 2007

(30) Foreign Application Priority Data
Sep. 22, 2006 (KR) 10-2006-92566

(51) Int. Cl. G05B 19/048

(52) U.S. Cl. 700/258; 15/339

(57) ABSTRACT

A tilt detectable automatically-operating cleaner includes a tilt detecting unit detecting a tilting state of a main body of the cleaner, a control unit calculating a tilting angle using a detected signal from the tilt detecting unit and determining if the main body tilts by comparing the tilting angle with a reference angle, a driving unit stopping driving of the cleaner when it is determined by the control unit that the main body tilts, and a suction unit controlling suction operation when it is determined by the control unit that the main body tilts

### CROSS-REFERENCE TO RELATED APPLICATIONS

This application claims the priority of Korean Patent Application No. 2006-92566, filed on Sep. 22, 2006, in the Korean Intellectual Property Office, the disclosure of which is incorporated herein by reference.

### BACKGROUND OF THE INVENTION

1. Field of the Invention

The present invention relates to an automatically-operating cleaner such as a robot cleaner, and more particularly, to a tilt detectable automatically-operating cleaner that can prevent the deterioration of working efficiency and unnecessary power consumption by temporarily stopping cleaning operation when the cleaner tilts or overturns during the cleaning operation and to a method of controlling the cleaner.

2. Description of the Related Art

In general, an automatically-operating cleaner such as a robot cleaner is designed to automatically clean a preset cleaning area in accordance with the detection of a sensor installed therein without manual control by a user.

The automatically-operating cleaner determines a cleaning area using an obstacle detecting sensor such as an infrared sensor installed on a main body of the cleaner and a mileage detecting sensor measuring a running distance and location by running a contour of an area enclosed by walls and/or obstacles, designs a cleaning path for cleaning the determined cleaning area, cleans the determined cleaning area by running the designed cleaning path while calculating a running distance using signals from a sensor detecting an RPM and rotational angle of wheels.

The automatically-operating cleaner may be lifted up or pressed down at its one side edge by, for example, a pet or a child. In some cases, it is so serious that the cleaner tilts or overturns by the pet or child. When there is no bump around steps, the cleaner may fall down the steps. That is, the cleaner may abnormally tilt or overturn by a variety of causes and thus it cannot normally perform the cleaning operation.

When the cleaner tilts or overturns, it is unnecessary to keep performing the cleaning operation. If the cleaner keeps performing the cleaning operation for a long time in a state where it tilts or overturns, the cleaner may be damaged and the working efficiency of the cleaner is deteriorated.

That is, when the cleaner tilts or overturns by a variety of external causes during the cleaning operation, the cleaner may not normally operate. In this case, there is no need to keep performing the cleaning operation. If the cleaner keeps performing the cleaning operation for a long time in a state where it tilts or overturns, the cleaner may be damaged and the cleaning efficiency of the cleaner is deteriorated.

### SUMMARY OF THE INVENTION

An aspect of the present invention provides a tilt detectable automatically-operating cleaner that can prevent the deterioration of cleaning efficiency and curb unnecessary power consumption by temporarily stopping cleaning operation when the cleaner tilts or overturns during the cleaning operation.

An aspect of the present invention also provides a method of controlling the cleaner.

According to an aspect of the present invention, there is provided a tilt detectable automatically-operating cleaner including: a tilt detecting unit detecting a tilting state of a main body of the cleaner; a control unit calculating a tilting angle using a detected signal from the tilt detecting unit and determining if the main body tilts by comparing the tilting angle with a reference angle; a driving unit stopping driving of the cleaner when it is determined by the control unit that the main body tilts; and a suction unit controlling suction operation when it is determined by the control unit that the main body tilts.

The tilt detectable automatically-operating cleaner may further include an alarming unit outputting alarm when it is determined by the control unit that the main body tilts.

The tilt detectable automatically-operating cleaner may further include an obstacle detecting unit performing obstacle detection in accordance with the control of the control unit and stopping the obstacle detection when it is determined that the main body tilts.

The tilt detectable automatically-operating cleaner may further include a manipulation unit for selecting operation starting/stopping of the cleaner.

During an operation stopping control by determination of the tilt of the main body, the control unit may control operation starting when an operation start command is input from the manipulation unit.

According to another aspect of the present invention, there is provided a method of controlling a tilt detectable automatically-operating cleaner, including: starting operation of the cleaner; detecting primarily a tilting angle of a main body of the cleaner; comparing the detected tilting angle with a reference angle; performing again the detection of the tilting angle when the detected tilting angle is less than the reference angle and stopping operation of the cleaner when the detected tilting angle is greater than the reference angle; and detecting secondly a tilting angle of the main body of the cleaner after the cleaner stops operating; comparing the secondly detected tilting angle with the reference angle; and maintaining a stopping state of the cleaner when the secondly detected tilting angle is greater than the reference angle and restarting the operation of the cleaner when the secondly detected tilting angle is less than the reference angle.

The method may further include outputting alarm when it is determined that the main body of the cleaner tilts.

The method may further include, after restarting the operation of the cleaner, determining if there is an operation ending command of the cleaner, performing the primary detection of the tilting angle when there is no operation ending command, and ending the operation of the cleaner when there is the operation ending command.

The method may further include, after stopping the operation of the cleaner, determining if there is a forced operation start command, restarting the operation of the cleaner when there is the forced operation start command, and performing the second detection of the tilting angle where there is no forced operation start command.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is block diagram of an automatically-operating cleaner according to an embodiment of the present invention;

FIGS. 2A and 2B are views illustrating tilting states of an automatically-operating cleaner by way of examples; and

FIG. 3 is a flowchart illustrating a method of controlling an automatically-operating cleaner according to an embodiment of the present invention.

### DETAILED DESCRIPTION OF THE PREFERRED EMBODIMENT

Reference will now be made in detail to the preferred embodiments of the present invention, examples of which are illustrated in the accompanying drawings. Wherever possible, the same reference numbers will be used throughout the drawings to refer to the same or like parts.

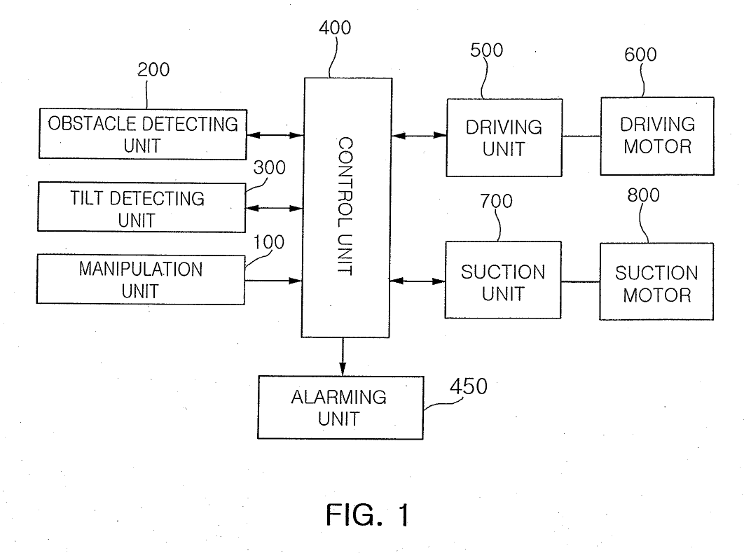

FIG. 1 is a block diagram of an automatically-operating cleaner according to an embodiment of the present invention.

Referring to FIG. 1, an automatically-operating cleaner of an embodiment the present invention includes a tilt detecting unit 300 for detecting the tilt of a main body of the cleaner, a control unit 400 for calculating a tilting angle using a detected signal from the tilt detecting unit 300, determining if the main body tilts by comparing the tilting angle with a reference angle, controlling driving and suction of the cleaner in accordance with the determination, and stopping the operation of the cleaner when it is determined that the main body tilts, a driving unit 500 for driving the cleaner in accordance with the control of the control unit 400 and stopping the driving of the cleaner when it is determined that the main body tilts, and a suction unit 700 for controlling suction operation of the cleaner in accordance with the control of the control unit 400 and stopping the suction operation when it is determined that the main body tilts.

The tilt detecting unit 300 may be a simple tilt sensor or an acceleration sensor for detecting acceleration.

As is well known, the acceleration sensor may be selected from the group consisting of a piezo-resistive type sensor, a capacitive type sensor, a tunneling type sensor, a resonant type sensor, and a thermal property type sensor.

The automatically-operating cleaner further includes a manipulation unit 100 for selecting operation starting/stopping of the cleaner, an obstacle detecting unit 200 for performing obstacle detection in accordance with the control of the control unit 400 and stopping the obstacle detection when it is determined that the main body tilts, and an alarming unit 450 for outputting tilt alarm when it is determined that the main body tilts.

Meanwhile, during the operation stopping control by the determination of the tilt, the control unit 400 controls the operation starting when the operation start command is input from the manipulation unit 100.

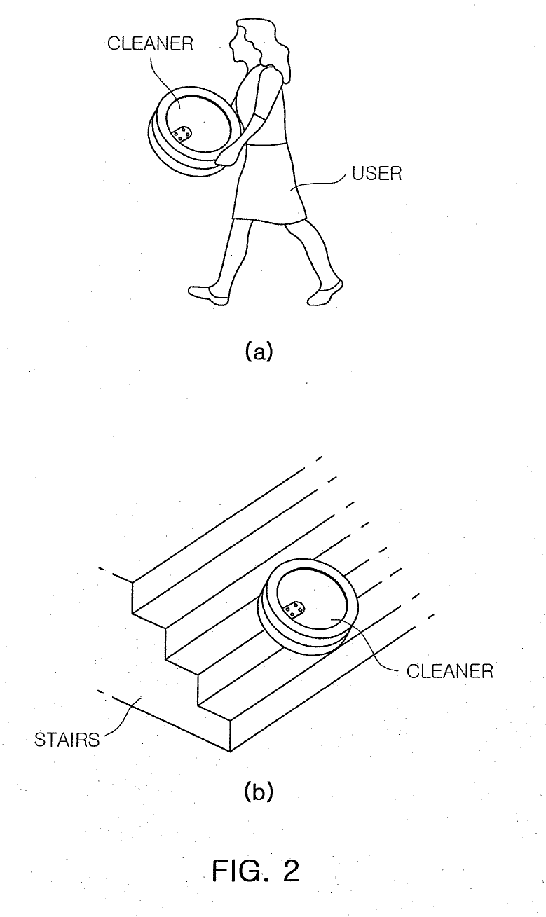

The tilting of the automatically-operating cleaner may be caused by a variety of factors. The following will describe the tilting states of the cleaner by way of examples with reference to FIGS. 2A and 2B.

FIGS. 2A and 2B are views illustrating tilting states of the automatically-operating cleaner by way of examples.

FIG. 2A shows a tilting state of the automatically-operating cleaner when a user grasps and lifts the cleaner during the cleaning work. FIG. 2B shows a tilting state of the automatically-operating cleaner when the cleaner goes down the stairs.

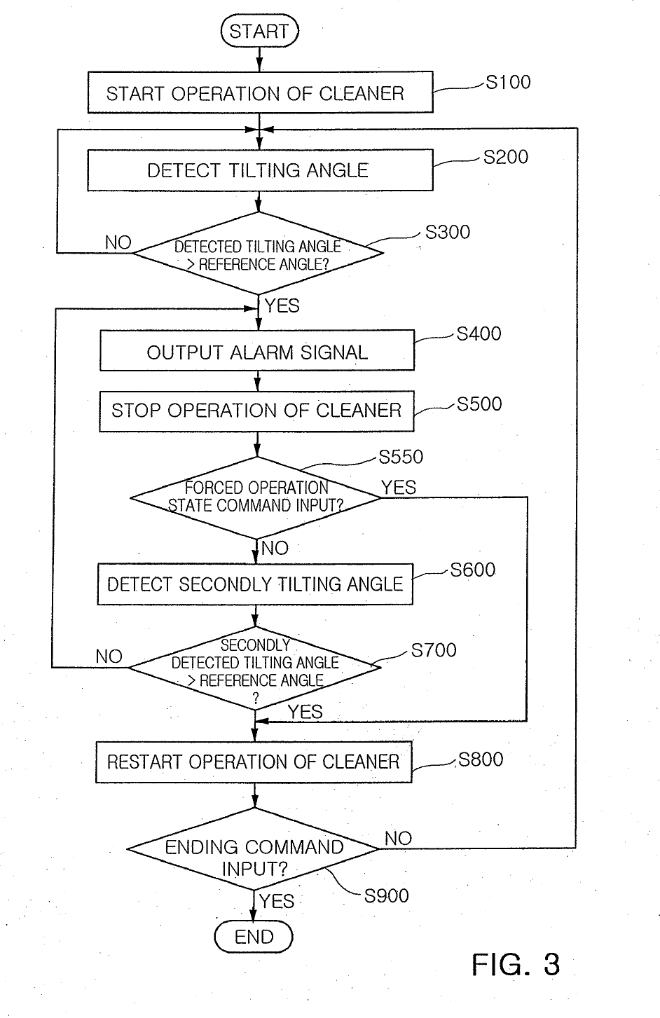

FIG. 3 is a flowchart illustrating a method of controlling the automatically-operating cleaner according to an embodiment of the present invention.

Referring to FIG. 3, in operation S100, the cleaner starts operating. In operation S200, the tilting angle of the main body is detected. In operation S300, the tilting angle of the main body is compared with a reference angle. In operation S400, the tilting alarm signal is output when it is determined that the main body tilts. In operation S500, when the tilting angle is less than the reference angle, the process is returned to operation S200 where the tilting angle of the main body is detected. When the tilting angle is greater than the reference angle, it is determined that the main body of the cleaner tilts to stop the operation of the cleaner. In operation S550, it is determined if there is a forced operation start command in the operation stopping state. When it is determined that there is the forced operation start command, the process proceeds to operation S800. When it is determined that there is no forced operation start command, the process proceeds to operation S600. In operation S700, the tilting angle of the main body is compared with a reference angle.

In operation S600, after the cleaner stops operating, the tilting angle of the main body of the cleaner is detected again. In operation S700, the tilting angle detected in operation S600 is compared with a reference angle. In operation S800, when the tilting angle is greater than the reference angle, it is determined that the main body of the cleaner tilts and thus the process is returned to operation S500 to stop the operation of the cleaner. In addition, when the tilting angle is less than the reference angle, it is determined that there is no tilt in the main body, the cleaner restarts operating. In operation S900, after the cleaner restarts operating, it is determined that if there is an operation end command. When there is no operation end command, the process is returned to operation S200. When there is the operation end command, the cleaner stops operating.

The following will describe the operation and effect of the automatically-operating cleaner of this embodiment.

Referring again to FIG. 1, when the user inputs operation start command of the cleaner through the manipulation unit 100 in a predetermined cleaning area, the control unit 400 identifies the operation start command from the manipulation unit 100 and detects an obstacle using the obstacle detecting unit 200. Then, the driving unit 500 operates the driving motor 600 associated with driving wheels in accordance with the control of the control unit 400. The suction unit 700 drives a suction motor 800 connected to a dust suction unit (not shown) in accordance with the control of the control unit 400, thereby performing the cleaning work.

In the above-described automatically-operating cleaner, the tilt detecting unit 300 detects a tilting state of the main body of the cleaner when the main body tilts as shown in FIGS. 2A and 2B and outputs the detected signal to the control unit 400. At this point, the detected signal output from the tilt detecting unit 300 corresponds to a tilting angle of the main body of the cleaner.

For example, when the tilt detecting unit 300 is the tilt sensor, the tilt sensor will output a signal corresponding to the tilting angle. When the tilt detecting unit 300 is the acceleration sensor, the acceleration sensor will output a signal including information on a tilting direction and a tilting angle.

The control unit 400 calculates the tilting angle using the detected signal from the tilting detecting unit 300 and compares the calculated tilting angle with the reference angle to determine if the main body tilts. Then, the control unit 400 controls the running and suction of the cleaner in accordance with the tilt determination result.

Here, the reference angle is a tilting angle at which the cleaner cannot normally perform the cleaning work. The reference angle may be variously set in accordance with an environment where the cleaner is used. For example, the reference angle may be 5-7 degrees.

When the reference angle is 5 degrees and the tilting angle detected by the tilt detecting unit 300 is 4 degrees, the control unit 400 determines that the main body of the cleaner does not tilt. When the tilting angle detected by the tilt detecting unit 300 is greater than 5 degrees or more, the control unit determines that the main body of the cleaner tilts.

Meanwhile, when the control unit 400 determines that the main body tilts, the control unit controls the driving unit 500 and the suction unit 700 such that the driving unit 500 stops the operation of the driving motor 600 to stop the driving of the cleaner and the suction unit 700 stops the operation of the suction motor 800 to stop the suction operation of the cleaner.

In addition, when the control unit 400 determines that the main body tilts, the obstacle detecting unit stops detecting the obstacles.

Furthermore, when the control unit 400 determines that the main body tilts, the control unit 400 controls the alarming unit 450 such that the alarming unit outputs alarm letting the user know the fact that the cleaner tilts. For example, the alarming unit 450 may be a buzzer outputting an alarming sound and/or a lamp outputting alarming light.

Therefore, when the automatically-operating cleaner tilts in an unstable posture, the cleaner stops operating and thus the functional deterioration that may be caused by the unnecessary operation can be prevented. Furthermore, unnecessary power consumption can be curbed.

Meanwhile, the control unit 400 can start again the operation of the cleaner by controlling the driving unit 500 and the suction unit 700 when the operation start command is input from the manipulation unit 100 during the operation stop of the cleaner by the tilt determination.

The following will describe a method of controlling the automatically-operating cleaner with reference to FIGS. 1 through 3.

As shown in FIG. 3, in operation S100, the cleaner starts operating.

That is, referring to FIG. 1, when the operation start command is input through the manipulation unit 100, the control unit 400 identifies this command and detects obstacles using the obstacle detecting unit 200. In addition, the driving unit 500 drives the driving motor 600 associated with the driving wheels to operate the cleaner in accordance with the control of the control unit 400. Further, the suction unit 700 drives the suction motor 800 connected to the dust suction unit, thereby performing the cleaning work.

Next, as shown in FIG. 3, in operation S200, the tilting angle of the main body of the cleaner is detected.

That is, referring to FIGS. 1 and 2, the tilt detecting unit 300 detects the tilting state of the main body and outputs a signal corresponding to the tilting state to the control unit 400. At this point, the tilt detecting unit 300 outputs a signal corresponding to the tilting angle of the main body.

For example, when the tilt detecting unit 300 is the tilt sensor, the tilt sensor will output a signal corresponding to the tilting angle. When the tilt detecting unit 300 is the acceleration sensor, the acceleration sensor will output a signal including information on a tilting direction and a tilting angle.

Next, as shown in FIG. 3, in operation S300, the tilting angle is compared with the reference angle.

That is, referring again to FIGS. 1 and 2, the control unit 400 calculates the tilting angle using the signal from the tilt detecting unit 300 and determines if the main body tilts by comparing the calculated tilting angle with the reference angle. In addition, the control unit 400 controls the driving and suction operation of the cleaner in accordance with the determination result.

Here, the reference angle is a tilting angle at which the cleaner cannot normally perform the cleaning work. The reference angle may be variously set in accordance with an environment where the cleaner is used. For example, the reference angle may be 5-7 degrees.

For example, when the reference angle is 5 degrees and the tilting angle detected by the tilt detecting unit 300 is 4 degrees, the control unit 400 determines that the main body of the cleaner does not tilt. When the tilting angle detected by the tilt detecting unit 300 is greater than 5 degrees or more, the control unit determines that the main body of the cleaner tilts.

Next, when the tilting angle is less than the reference angle, the process is returned to operation S200 where the tilting angle is detected. When the tilting angle is greater than the reference angle, it is determined that the cleaner tilts to stop the operation of the cleaner (S500).

That is, referring again to FIGS. 1 and 2, when the control unit 400 determines that the main body tilts, the control unit controls the driving unit 500 and the suction unit 700 such that the driving unit 500 stops the operation of the driving motor 600 to stop the driving of the cleaner and the suction unit 700 stops the operation of the suction motor 800 to stop the suction operation of the cleaner.

In addition, when the control unit 400 determines that the main body tilts, the obstacle detecting unit stops detecting the obstacles.

Next, in operation S600, after the cleaner stops operating, the tilting angle of the main body of the cleaner is detected again. In operation S700, the tilting angle detected in operation S600 is compared with a reference angle.

In operation S800, when the tilting angle is greater than the reference angle, it is determined that the main body of the cleaner tilts and thus the process is returned to operation S500. In addition, when the tilting angle is less than the reference angle, it is determined that there is no tilt in the main body, the cleaner restarts operating.

In operation S900, after the cleaner restarts operating, it is determined that if there is an operation end command. When there is no operation end command, the process is returned to operation S200. When there is the operation end command, the cleaner stops operating.

In operation S550, it is determined if there is a forced operation start command in the operation stopping state. When it is determined that there is the forced operation start command, the process proceeds to operation S800. When it is determined that there is no forced operation start command, the process proceeds to operation S600.

Meanwhile, in operation S400, the tilting alarm is output when it is determined that the main body tilts.

As described above, when an unstable event where the automatically-operating cleaner performs cleaning work while moving in a predetermined area, that is, when the cleaner tilts or overturns by external physical force, e.g., by falling down the stairs, the cleaner automatically stops operating.

According to the present invention, the tilt detectable automatically-operating cleaner can prevent the decrease of working efficiency and curb unnecessary power consumption by temporarily stopping cleaning operation when the cleaner tilts or overturns during the cleaning operation.

While the present invention has been shown and described in connection with the exemplary embodiments, it will be apparent to those skilled in the art that modifications and variations can be made without departing from the spirit and scope of the invention as defined by the appended claims.

What is claimed is:

1. A tilt detectable automatically-operating cleaner comprising:
a tilt detecting unit detecting a tilting state of a main body of the cleaner;
a control unit calculating a tilting angle using a detected signal from the tilt detecting unit and determining if the main body tilts by comparing the tilting angle with a reference angle;
a driving unit stopping driving of the cleaner when it is determined by the control unit that the main body tilts; and
a suction unit controlling suction operation when it is determined by the control unit that the main body tilts.

2. The tilt detectable automatically-operating cleaner of claim 1, further comprising an alarming unit outputting alarm when it is determined by the control unit that the main body tilts.

3. The tilt detectable automatically-operating cleaner of claim 1, further comprising an obstacle detecting unit performing obstacle detection in accordance with the control of the control unit and stopping the obstacle detection when it is determined that the main body tilts.

4. The tilt detectable automatically-operating cleaner of claim 1, further comprising a manipulation unit for selecting operation starting/stopping of the cleaner.

5. The tilt detectable automatically-operating cleaner of claim 4, wherein, during an operation stopping control by determination of the tilt of the main body, the control unit controls operation starting when an operation start command is input from the manipulation unit.

6. A method of controlling a tilt detectable automatically-operating cleaner, comprising:
starting operation of the cleaner;
detecting primarily a tilting angle of a main body of the cleaner;
comparing the detected tilting angle with a reference angle;
performing again the detection of the tilting angle when the detected tilting angle is less than the reference angle and stopping operation of the cleaner when the detected tilting angle is greater than the reference angle; and
detecting secondly a tilting angle of the main body of the cleaner after the cleaner stops operating;
comparing the secondly detected tilting angle with the reference angle; and
maintaining a stopping state of the cleaner when the secondly detected tilting angle is greater than the reference angle and restarting the operation of the cleaner when the secondly detected tilting angle is less than the reference angle.

7. The method of claim 6, further comprising outputting alarm when it is determined that the main body of the cleaner tilts.

8. The method of claim 6, further comprising, after restarting the operation of the cleaner, determining if there is an operation ending command of the cleaner, performing the primary detection of the tilting angle when there is no operation ending command, and ending the operation of the cleaner when there is the operation ending command.

9. The method of claim 6, further comprising, after stopping the operation of the cleaner, determining if there is a forced operation start command, restarting the operation of the cleaner when there is the forced operation start command, and performing the second detection of the tilting angle where there is no forced operation start command.
